(19) United States
(12) Patent Application Publication
(10) Pub. No.: US 2015/0332245 A1
(43) Pub. Date: Nov. 19, 2015

(54) Consumer Purchase Database Assistance

(71) Applicants: Michael Meyer, Dove Canyon, CA (US); Julie Flores, Costa Mesa, CA (US)

(72) Inventors: Michael Meyer, Dove Canyon, CA (US); Julie Flores, Costa Mesa, CA (US)

(73) Assignee: Clear Coverage Technology, LLC, Irvine, CA (US)

(21) Appl. No.: 14/280,604

(22) Filed: May 17, 2014

(51) Int. Cl. G06Q 20/22; G06Q 30/06

(52) U.S. Cl. CPC G06Q 20/227; G06Q 30/0645

(57) ABSTRACT

This present invention provides an interface at the time of a transaction that communicates with at least one database that contains information regarding the consumer's available payment options. The system then compares the characteristics with various factors regarding the retailer or purchase to match the most suitable payment option with the transaction, and provides that information to the consumer or retailer.

### CROSS-REFERENCE TO RELATED APPLICATION

This application claims priority benefit of U.S. Provisional Patent Application No. 61/825,021 entitled “Consumer Purchase Database Assistance,” filed May 18, 2013. The disclosure in that application is incorporated herein in its entirety.

### BACKGROUND AND SUMMARY

The present invention relates generally to consumer purchase database systems, and more particularly to computerized insurance coverage assistance.

There currently does not exist a solution for optimizing the specific method of consumer payment based on factor surrounding the purchase, such as the most suitable type of insurance available on a payment card for the purchase, rewards points, most optimal interest rate, and so on. Throughout this application, the terms payment card, payment card, or bank card may be used interchangeably to refer to any type of card that transfers payment from an account to a payee. This can also include an electronic funds transfer account, such as a wireless payment card or NFC (near field communication) card.

The present invention solves those problems by providing an interface at the time of a transaction that communicates with at least one database that contains information regarding the consumer's available payment options. The system then compares the characteristics with various factors regarding the retailer or purchase to match the most suitable payment option with the transaction, and provides that information to the consumer or retailer.

More specifically, as one non-limiting example of the system, a consumer may begin a transaction to rent a car at a rental car provider. As the rental transaction is initiated, the computerized transaction may then search for the payment card's profile in a database to determine the different types of benefits and restrictions the payment card places upon the rental transaction. If multiple payment cards are searched, the database can compare those payment card options to determine which one provides the most comprehensive rental car insurance, or which one provides the best insurance under the local insurance laws of the rental location, as well as other factors. Then the system can suggest the most optimal payment card to the transaction location, for use in the transaction.

### BRIEF DESCRIPTION OF THE DRAWINGS

FIG. 1 is a layout schematic of the different interactions and subsystems of one embodiment of the consumer purchase database assistance system.

FIG. 2 is a flowchart showing the operation of one embodiment of the system.

### DETAILED DESCRIPTION

While the exemplary embodiments illustrated herein may show various features, it will be understood that the different features disclosed herein can be combined variously to achieve the objectives of the present invention.

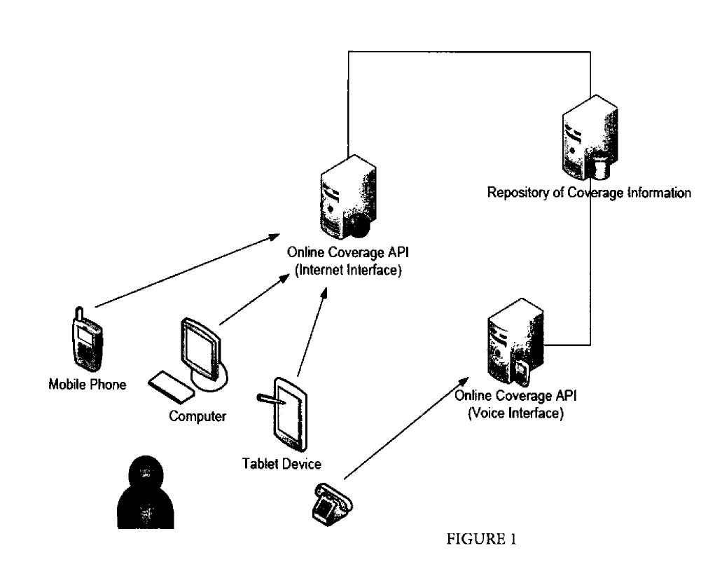

Turning to FIG. 1, this figure shows one embodiment of the consumer purchase database assistance system. In this embodiment, a user of the system accesses the system through a computer or telephone interface. A computer interface can include any type of input device, such as a computer, tablet, mobile phone, payment card swiper, or similar. In addition, the “user” can be either a consumer or the retailer that is initiating a purchase with the consumer. The system can also be accessed through a voice system, or telephone-based interactive system.

The user inputs data regarding the transaction into the system through a system interface. One example of such an interface can be an application programming interface (API), which can either be resident on the remote system, or resident in an application on the computer. This interface then communicates with a remote repository database, which contains information about the payment options and information about each payment option relevant to the purchase. The relevant features of the payment card provided by the consumer are then returned to the user for his or her information. For example, if insurance provisions of the payment card provided by the consumer can be listed for his information prior to completing the transaction. In an alternative embodiment, the most suitable payment option is selected from the options, then returned to the user. Most suitable can be any relevant criteria. As non-limiting options, this can include which option has the most comprehensive insurance available, which would provide the most rewards points, or similar criteria. For the purposes of this application, “retailer” can mean any goods or services provider, as well as wholesalers or business-to-business providers.

Note that in this figure, it shows one embodiment of the system in which the local device (phone, tablet, or computer) interacts with a remote API, which, in turn, interacts with a remote database. It is understood, however, that various embodiments of the system may have the different aspects of the software system (different modules, or different subsystems) at different locations in the system. For example, the API itself may be resident on the mobile device. Or, in another embodiment, the API may be remote from the mobile device, but the repository itself may be resident on that system where the API is. The repository may be on the mobile device. Or, the repository may be accessed from the software on the mobile device, when given a call—or transaction information transmitted—from the system where the API resides, which is likely a point-of-sale (POS) system. One skilled in the art understands that these different functions of the software—querying aspects, analysis aspects, database aspects, and so on—may be variously configured throughout the purchaser's device, the POS system, and a remote system accessed over a network in order to achieve certain goals for a given system.

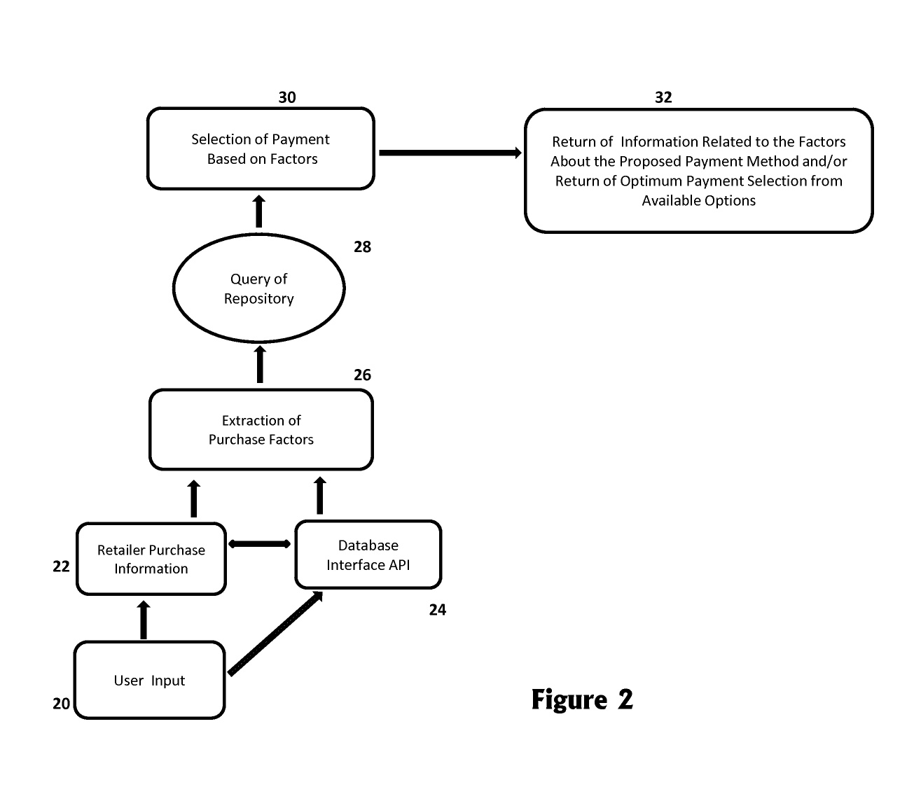

Turning to FIG. 2, this figure shows a flowchart of one embodiment of the system. First, input regarding the transaction is input 20 from the user of the system into the interface. This information may be input to the system interface API 24 or to the retailer purchase system 22, or to both simultaneously. For example, in one option of the system, the API may be a standalone interface residing on a computer that communicates the purchase and retailer information to the repository. However, in another embodiment, the retailer's point of service (POS) terminal may have not only a purchase application, but also the payment optimization API 24 resident in the POS for automatic use with a purchase. In yet another embodiment, a user may initiate a transaction on the internet by providing input 20 to a retailers purchase interface 22. The user may have a standalone purchase optimization program operating, for example, as a plug-in to his or her browser. In this case, the API 24 works in conjunction with the retailer interface 22. In yet another embodiment, the API may be completely independent and separate from the retailer's systems.

There are a variety of configurations whereby the API 24 is located relative to the retailer purchase application 22. As stated previously, the various functions represented in the flowchart can reside on various parts of the overall system, or in various locations, depending how the system is designed. However, regardless of that configuration, the API must gather and extract relevant purchase factors 26 from the purchase. In the non-limiting example of a car rental transaction, these factors may include the type of transaction (car rental), the location of the rental, the type of vehicle, and so on. The types of factors can be any factor relevant to the selection of a payment type. In a transaction module, the relevant factors of the type of purchase, as well as an identification of the purchaser (which can be a number, an ID name, or similar), are collected. Using these factors, a query 28 is generated and sent to the repository database. This query would compare the relevant purchase factors to the relevant features of different payment types. For example, if the transaction is a car rental the query may compare the rental factors against the car rental insurance provisions of each payment card available to the renter. Then, the repository can be configured to select 30 the most suitable payment option or payment card applicable to the transaction. As one possible example, if one payment card offers insurance with no deductible, while another card provides insurance with a deductible, the no deductible card would be selected. Or, if one card covers truck rentals, and another card does not, the truck rental payment card may be selected for when the truck is provided as one of the factors. And so on. The optimization criteria may be pre-programmed into the repository, or preselected by the user. Then, the optimal payment card can be returned to the user 32. This can be simply provided as a recommended option for the user to select. Or, it can be automatically selected and applied to the purchase and the retailer's POS system. Alternatively, the repository system can simply analyze the one payment card provided by the consumer, and analyzed for the car insurance provisions and limitations, and that information provided to the consumer for his own information.

In the non-limiting preferred embodiment of a car rental transaction, a consumer can arrange to rent a car from a car rental provider. At the initiation of the transaction—which can be online or in a rental office—the user of the disclosed payment optimization system can input the details of the pending transaction into the interface of the payment optimization system. Again, the user can be the consumer him or herself, using a standalone API interface on his or her smartphone, for example. Or, the API can be built into the rental car POS system or website, and automatically used to send details of the transaction to the payment optimization system. The relevant information about the rental transaction, such as the type of car, location of rental, and so on, is provided to the consumer database repository, possible across a network or internet connection. The repository can then research the type of payment card provided by the consumer in order to provide the car rental insurance provisions of the payment card to the consumer, so that the consumer can know if he or she needs to purchase additional insurance that the payment card does not provide. For example, the repository may determine that the provided payment card does not provide collision insurance or that payment card insurance is not provided in the location he is renting in. The repository may hold information about the consumer and his available payment cards, or it may simply hold information about a variety of different payment cards whether the consumer has those cards or not. Then, the consumer can decide whether to purchase additional insurance from the rental car agency. In a variation on this embodiment, the repository may search the various payment cards that the user owns, and analyze their various insurance provisions, then determine which one is the most suitable for the transaction. For example, if the user is renting in Mexico, and only one of his or her payment cards provides insurance for rentals there, that payment card can be returned to the consumer (or retailer) as the best payment card to be used for the rental. Or, a particular payment card may provide a benefit for renting from Hertz, where the consumer is renting, for example. Then, the detailed information could be provided for a manual selection, or the best could be automatically applied to the transaction. The database with the payment card information could be centralized, holding all of the information which the user has requested to be added. Or, it could be disparate, such that various payment cards are queried from other databases, such as through a payment reporting agency.

In a variation of the preferred embodiment, other types of transactions, and types of relevant factors could be used with the payment system. For example, when purchasing airline tickets, the input API could be used to send information about the purchase (such as which airline) could be sent to the repository, and the payment card that would provide the most airline miles for the purchase could be returned to the consumer. Therefore, the payment card rewards would be optimized if the consumer used the payment card suggested by the information system. In yet another embodiment, the repository could analyze whether a user would get a particular rewards benefit due to the timing of using a card for a purchase. As an example, a consumer's rewards points may increase to a higher earning level if he or she made an additional purchase in a particular month. Then, the repository could recommend that the consumer use that payment card for his next purchase. Another embodiment of the system could optimize payment card use according to the lowest interest rate on a particular card, and recommend that that card be used. The type of retailer could automatically be determined from the API by analyzing the retailer or goods implicated in the purchase. Or, it could be input by the user through the API.

In yet another embodiment, the system can be embedded in a smart card payment card collector. The API can be resident on the SIM card, such that it automatically takes in the relevant factors about the pending transactions, then searches its internal information about the types of payment cards the user holds in his payment card collector, the determines the most suitable for the transaction. Then, the payment card collector can apply the most suitable card to the transaction automatically.

Any combination of the above features and options could be combined into a wide variety of embodiments. It is, therefore, apparent that there is provided in accordance with the present disclosure, systems and methods for implementing consumer purchase systems. While this invention has been described in conjunction with a number of embodiments, it is evident that many alternatives, modifications, and variations would be, or are apparent to, those of ordinary skill in the applicable arts. Accordingly, applicants intend to embrace all such alternatives, modifications, equivalents and variations that are within the spirit and scope of this invention.

What is claimed is:

1. A system for the selection of a payment method in a transaction, the system comprising:
a transaction module that collects the information about a transaction and information about the consumer in said transaction,
a querying module that queries said payment database for characteristics related to at least one payment method available to said consumer,
a reception module that receives data regarding the at least one payment method from said payment database, and
a selection module that selects the most suitable payment method for the transaction based on the information about said transaction, information about said consumer, and said characteristics.

2. The system of claim 1, wherein the payment method is at two or more payment cards, and wherein said selection module selects the most suitable payment card from those payment cards.

3. The system of claim 2, wherein said transaction is a car rental and said characteristics related to at least one payment method is rental car insurance provided by the payment card to the purchaser.

4. The system of claim 3, wherein said information about the transaction is one of: the car rental location, the type of vehicle rented, or local laws regarding car rental insurance.

5. The system of claim 3, wherein said selection module selects the payment card with the best insurance coverage available for the car rental transaction.

6. The system of claim 2, wherein said characteristics related to at least one payment method are rewards provided by the payment card for the transaction.

7. The system of claim 1, wherein said information about the consumer is an identifier that allows the database to determine the payment methods available to that consumer.

8. The system of claim 1, wherein said payment database resides on the same system as the querying module and reception module.

9. The system of claim 1, wherein said payment database is remote from the querying module and reception module, and further comprising a communication module to communicate with the remote payment database.

10. The system of claim 9, wherein the selection module resides in the remote payment database.

11. The system of claim 1, wherein the system resides on the consumer's mobile device.

12. The system of claim 1, wherein the system resides in a payment card collector system.

13. A system on a non-transitory computer medium for the selection of a payment method in a transaction, the system comprising:
a transaction subsystem that receives transaction and purchaser data from a point of sale system,
a database that contains data regarding the payment methods available to said purchaser,
an analysis subsystem that analyzes said data regarding the payment methods available to said purchaser and the transaction data to determine the best payment method for said transaction,
an output subsystem that returns the best payment method to the point of sale system.

14. The system of claim 13, wherein the transaction is a car rental, the payment methods are payment cards, and the best payment method is selected by determining the payment card that offers the best car rental insurance for the car rental transaction.

15. The system of claim 13, wherein the system resides on a network in communication with said point of sale system.

16. The system of claim 13, wherein the system resides on said purchaser's mobile device.

17. The system of claim 13, wherein the system is accessed through a browser.

18. The system of claim 13, wherein the system resides on a payment card collector system.

19. A method on a non-transitory computer medium for determining the best payment method to use in a transaction, the method comprising:
recording the transaction data for a particular purchase,
identifying the customer in said purchase,
searching the payment methods available to said customer for said purchase,
analyzing the payment methods available and the transaction data to determine the best payment method for the purchase,
outputting said best payment method for the purchase to a system, such that the receiving system can display said best payment method on a computer display.

20. The method of claim 19, wherein the purchase is a car rental, the payment methods are payment cards, the transaction data includes the location of the rental, and the best payment method is determined by analyzing the payment methods and the transaction data to determine which payment card offer the best insurance for the car rental.
